(19) United States
(12) Patent Application Publication
(10) Pub. No.: US 2026/0059585 A1
(43) Pub. Date: Feb. 26, 2026

(54) COLLISION ARBITRATION BASED ON ENERGY LEVELS

(71) Applicant: Nokia Technologies Oy, Espoo (FI)

(72) Inventors: Yonggang WANG, Shanghai (CN); Nitin MANGALVEDHE, Naperville, IL (US); Xiaomao MAO, Massy (FR); Muhammad Majid BUTT, Naperville, IL (US)

(21) Appl. No.: 19/115,887

(22) PCT Filed: Oct. 31, 2022
(86) PCT No.: PCT/CN2022/128658

§ 371 Date: Mar. 27, 2025

(51) Int. Cl. H04W 74/0833; H04W 52/02

(52) U.S. Cl. CPC H04W 74/085; H04W 52/0238

(57) ABSTRACT

Embodiments of the present disclosure relate to collision arbitration based on energy levels. A terminal device is provided comprising at least one processor and at least one memory storing instructions. The instructions, when executed by the at least one processor, cause the terminal device at least to: receive, from a second device, configuration information of a plurality of energy levels; determine, based on the configuration information, an energy level to which the first device corresponds from the plurality of energy levels; receive a query message from the second device; and based on the query message, provide a response message to the second device in a slot selected by the first device from a set of slots associated with the energy level. As such, the power consumption of system is minimized and arbitration time is reduced.

### TECHNICAL FIELD

Various example embodiments relate to the field of communication, and in particular, to devices, methods, apparatuses and computer readable storage media for collision arbitration based on energy levels.

### BACKGROUND

Energy harvesting enabled communication services in 5G system has been approved as a new study item for the Rel-19. Energy harvesting enabled communication services have already been widely used in various vertical industries including logistics, manufacture, transportation, energy industry, etc. Enabling energy harvesting in 5G system, including both public land mobile network (PLMN) and non-public network (NPN), would benefit the whole 5G ecosystem.

### SUMMARY

In general, example embodiments of the present disclosure provide devices, methods, apparatuses and computer readable storage media for collision arbitration based on energy levels.

In a first aspect, there is provided a first device. The first device comprises at least one processor, and at least one memory storing instructions. The instructions, when executed by the at least one processor, cause the first device at least to: receive, from a second device, configuration information of a plurality of energy levels; determine, based on the configuration information, an energy level to which the first device corresponds from the plurality of energy levels; receive a query message from the second device; and based on the query message, provide a response message to the second device in a slot selected by the first device from a set of slots associated with the energy level.

In a second aspect, there is provided a second device. The second device comprises at least one processor, and at least one memory storing instructions. The instructions, when executed by the at least one processor, cause the second device at least to: transmit, to a plurality of devices, configuration information of a plurality of energy levels; transmit at least one query message to the plurality of devices; and receive, from a first device of the plurality of devices, a response message corresponding to a query message of the at least one query message in a slot of a set of slots associated with an energy level among the plurality of energy levels.

In a third aspect, there is provided a method. The method comprises: receiving, at a first device and from a second device, configuration information of a plurality of energy levels; determining, based on the configuration information, an energy level to which the first device corresponds among the plurality of energy levels; receiving a query message from the second device; and based on the query message, provide a response message to the second device in a slot selected by the first device from a set of slots associated with the energy level.

In a fourth aspect, there is provided a method. The method comprises: transmitting, at a second device and to a plurality of devices, configuration information of a plurality of energy levels; transmitting at least one query message to the plurality of devices; and receiving, from a first device of the plurality of devices, a response message corresponding to a query message of the at least one query message in a slot of a set of slots associated with an energy level among the plurality of energy levels.

In a fifth aspect, there is provided an apparatus. The apparatus comprises means for performing the method according to the third or fourth aspect.

In a sixth aspect, there is provided a computer readable medium comprising program instructions. The instructions, when executed by an apparatus, cause the apparatus to perform the method according to the third or fourth aspect.

In a seventh aspect, there is provided a computer program comprising instructions, which, when executed by an apparatus, cause the apparatus at least to perform the method according to the third or fourth aspect.

In an eighth aspect, there is provided a device. The device comprises circuitries for performing at least: receiving, at a first device and from a second device, configuration information of a plurality of energy levels; determining, based on the configuration information, an energy level to which the first device corresponds among the plurality of energy levels; receiving a query message from the second device; and based on the query message, provide a response message to the second device in a slot selected by the first device from a set of slots associated with the energy level.

In a ninth aspect, there is provided a device. The device comprises circuitries for performing at least: transmitting, at a second device and to a plurality of devices, configuration information of a plurality of energy levels; transmitting at least one query message to the plurality of devices; and receiving, from a first device of the plurality of devices, a response message corresponding to a query message of the at least one query message in a slot of a set of slots associated with an energy level among the plurality of energy levels.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication system in which implementations of the present disclosure can be implemented;

FIG. 2 illustrates an example flowchart showing an example process for collision arbitration based on energy levels in accordance with some embodiments of the present disclosure;

FIG. 3 illustrates an example diagram of a relationship between the slots and the energy levels in accordance with some embodiments of the present disclosure;

FIG. 4 illustrates an example diagram of a deployment of tags and the energy levels in accordance with some embodiments of the present disclosure;

FIG. 5 illustrates an example flowchart showing an example detailed process of collision arbitration based on energy levels in accordance with some embodiments of the present disclosure;

FIG. 6 illustrates an example diagram of the response of each tag for the query message in accordance with some embodiments of the present disclosure;

FIG. 7 illustrates an example flowchart showing an example process of dynamic parameters determination for energy levels in accordance with some embodiments of the present disclosure;

FIG. 8 illustrates a flowchart of an example method implemented at a first device in accordance with some embodiments of the present disclosure;

FIG. 9 illustrates a flowchart of an example method implemented at a second device in accordance with some embodiments of the present disclosure;

FIG. 10 shows a simplified block diagram of a device that is suitable for implementing example embodiments of the present disclosure; and

FIG. 11 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communication between a terminal device and a network device in the communication network may be performed according to any suitable generation communication protocols, including, but not limited to, the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communication, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device (e.g., passive IoT devices), a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As described, enabling energy harvesting in 5G system (5GS) would benefit the whole 5G ecosystem. Energy harvesting enabled communication services are aimed at the following usage scenarios:
1) under extreme environmental conditions, e.g., high pressure, extremely high/low temperature, humid environment, vibration, etc.;
2) ultra-low complexity (cost), very small terminal size/form factor (e.g., thickness of mm), maintenance-free and longer life cycle, etc.; and
3) Other scenarios where a terminal driven by a battery is not applicable.

Therefore, energy harvesting enabled communication services, using either battery-less terminal or terminal with limited energy storage capability (e.g., using a capacitor), could become a new requirement the existing 3GPP technologies cannot support yet.

Typically, a terminal based on energy harvesting operates in a passive mode. The terminal itself uses energy harvested from wireless radio waves or any other form of energy that can be harvested in the particular use cases and is expected to only support ultra-low power in the range from tens of microwatts to hundreds of microwatts.

The following summarizes some design targets for Passive IoT: improved link budget compared to existing radio frequency identification (RFID) solutions; frequency bands for global usability, e.g., licensed and unlicensed; ultra-low cost (e.g., $0.02-$0.5); no need for battery charging or replacement (enabling low maintenance long life cycle operation); ultra-low power (e.g., <100 micro-Watts, to enable operation with back-scattering or energy harvesting); small device size, form-factor; positioning accuracy (e.g., 3-5 m); data rate (e.g., 10-100 kbps); energy source, e.g., use of backscattering techniques for passive devices, and devices operating with energy harvesting or with a very small battery (e.g., <100 mAh) for semi-passive devices; and mobile originated and mobile terminated data.

Some embodiments of the present disclosure may relate to a backscattering technique, which is introduced below. A candidate technology for ultra-low energy or zero-energy devices is backscattering, which may generally be used between a reader and a tag. A reader may include interrogator, entrance guard, Electronic Toll Collection, and/or the like. According to the custom, passive IoT device may be also called tag. A tag may include metro card, access card, electronic label, health care monitoring chip, and/or the like. A reader sends a radio frequency (RF) signal which illuminates a tag, the tag modulates the incident RF signal with an information-bearing signal, and the reflected signal is demodulated at a reader. All backscattering systems are reader talks first (RTF), that is, the tag modulates the reflection wave with its stored information after receiving the signal sent by the reader.

RFID based on electronic product code (EPC) Gen2 can support 40 kbps-640 kbps data rates from tag to reader with a sensitivity of −85 dBm. Typical rates vary between 60-70 kbps using Miller (M=4) encoding. For RFID, typical ranges of 3 m can be achieved using passive transponders and ranges up to 30 m can be achieved using active transponders. All long-range systems operate using ultra high frequency (UHF) or microwave frequencies and use backscattered modulation to communicate with the reader.

From the cost, complexity, and life cycle point of view, a passive IoT device in a 5G system with RF harvesting, backscattering, and energy storage using a capacitor may be an optimal solution. Radio technology needs to be studied, such as to support backscattering communication and RF energy harvesting; to extend the communication range of passive devices, for example, the harvested energy may be used to enhance the backscattering signal and not to actively communicate.

Some embodiments of the present disclosure may be suitable for the aforementioned passive IoT in 3GPP cellular network scenarios. Some embodiments of the present disclosure may also be suitable for passive IoT with other types of energy harvesting and energy storage.

Some embodiments of the present disclosure may relate to a collision arbitration, which is introduced below. The purpose of the collision arbitration sequence is to perform a census of the tags present in the reader field and to receive information on the tag capabilities and data contents, all in a single sequence. The information that the tag shall backscatter, return, transmit, or otherwise provide is specified by flags set in the command from the reader. The reader is the master of the communication with one or multiple tags.

Typically, in the ISO-IEC 18000-6 air interface communications of RFID at 860-930 MHz,
ISO 18000-6 type A collision arbitration mechanism applies the ALOHA algorithm,
ISO 18000-6 type B collision arbitration mechanism applies the Binary tree algorithm, and
ISO 18000-6 type C collision arbitration mechanism applies the Slotted random collision arbitration.

As an example, the collision arbitration mechanism in ISO 18000-6 type C is briefly described. The Inventory command set in 18000-6 type C includes Query, QueryAdjust and QueryRep. The arbitration algorithm includes the following steps.
Step 1: Reader sends a Query command. Query initializes an inventory cycle which contains a parameter Q (1˜15).
Step 2: When receiving a Query command, the participating tags select a random number within the range of (0, 2Q−1) and put this number into their slot counter.
Step 2.1. The tags that selected zero value should respond immediately, and reply a RN16; and Step 2.2. Tags that selected non-zero numbers should wait for a QueryAdjust or QueryRep command.
Step 3: The reader detects a RN16 (e.g., a unique identity of tag) and confirms to the tag with the ACK command containing the same RN16.
Step 4: Otherwise, the reader sends QueryRep. On receiving a QueryRep, tags decrement their slot counter by one. When their slot counter decreases to 0, the tags reply a RN16.
Step 5: QueryAdjust repeats the Query operation and can increase or decrease Q but does not introduce new tags.

In the cellular network scenarios, some passive IoT devices will be far away from gNB, while others will be close. The far passive IoT devices need to harvest more energy to transmit a signal sufficient for the gNB to receive. For example, a far UE may receive gNB's command signal (e.g., query message) many times but respond once with the support of stored energy. However, a near passive IoT device may respond after receiving only one command signal from gNB.

This problem is not considered in current collision arbitration mechanisms. If it is intended that the far passive IoT device must respond immediately after harvesting energy from one command signal, the gNB needs to send a very high-powered signal. For the near passive IoT device, the excessive power may be wasted. Thus, a collision arbitration scheme is required that solves this problem without using high energy signals. A collision arbitration based on energy levels for energy harvesting passive IoT in 5GS needs to be developed.

In a collision arbitration mechanism, the tag loads a random number into its slot counter. According to the command of the reader, the slot counter continuously decreases by 1. When the slot counter reaches zero, the tag responds to the command of the reader. The legacy RFID is a type of near field communication, and RFID has no energy harvesting and storage functionality, so it does not consider the far tag's potential inability to receive the signal or the power efficiency of the reader. But in the cellular deployment, some passive IoT devices will be far from the gNB or a reader, while others will be close. The far passive IoT devices need to harvest more energy to transmit a signal sufficient for the gNB or the reader.

According to embodiments of the present disclosure, there is providing solutions on the energy levels definition and the collision arbitration based on the energy levels for energy harvesting passive IoT in 5GS. An energy level may be associated with different values of a measurement at the passive IoT devices based on an energy level selection criterion. The slots used by passive IoT devices to provide responses can be divided into several groups corresponding to the number of energy levels. The passive IoT device can determine its energy level according to the level of a measurement such as a received signal power (e.g., reference signal receiving power (RSRP)) measurement result, a synchronization signal and physical broadcast channel block (SSB) index measurement result, or a distance measurement to a reference location based on a location of the passive IoT device. Then, during the collision arbitration procedure, the passive IoT devices may respond to a query (e.g., a query message, a query signal, a command signal, etc.) from a reader (e.g., a gNB or reader device, such as a terminal device acting as a reader, etc.) in the slots assigned to the corresponding energy level. In this way, the reader may repeatedly transmit the query messages without increasing transmission power, then the near passive IoT devices can respond first, while the far passive IoT devices can respond later, for example, after receiving the a query a certain number of times. Therefore, the power consumption may be minimized. Furthermore, the slot number can be configurable between query cycles. After each subsequent query cycle, collision arbitration may be performed more accurately and/or more efficiently, and thereby also reduce arbitration time.

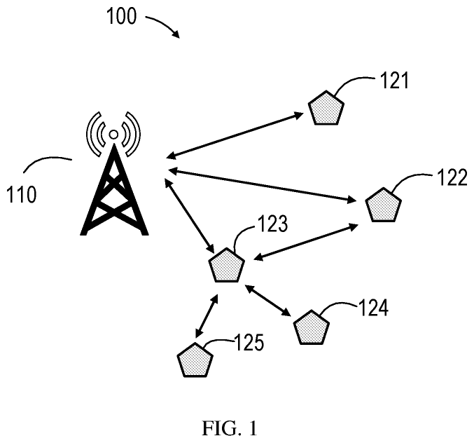

FIG. 1 illustrates an example communication system 100 in which implementation aspects of the present disclosure can be implemented. As shown in FIG. 1, the communication network 100 may include a network device 110 (e.g., a base station, such as a gNB) and terminal devices 121-125 (e.g., energy harvesting devices). The network device 110 may communicate with the terminal devices 121-123 via respective wireless communication channels. In some cases, the terminal device 123 may directly communicate with other terminal devices (e.g., the terminal devices 122, 124, and 125) using suitable communication technologies, e.g., sidelink or backscattering. For example, the terminal device 123 may act as a relay of the network device 110.

It is to be understood that the number of network devices and terminal devices and the specific interactions between them are only for the purpose of illustration without suggesting any limitations. The system 100 may include any suitable number of network devices and terminal devices adapted for implementing embodiments of the present disclosure. In the following description, the terminal devices may also be referred to as passive IoT devices or tags. Therefore, the terms “first device”, “terminal device”, “UE”, “energy harvesting device”, “passive IoT device” and “tag” may be used interchangeably herein.

It is to be understood that the number of devices in FIG. 1 is given for the purpose of illustration without suggesting any limitations to the present disclosure. Communication in the system 100 may be implemented according to any proper communication protocol(s), comprising, but not limited to, cellular communication protocols of the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

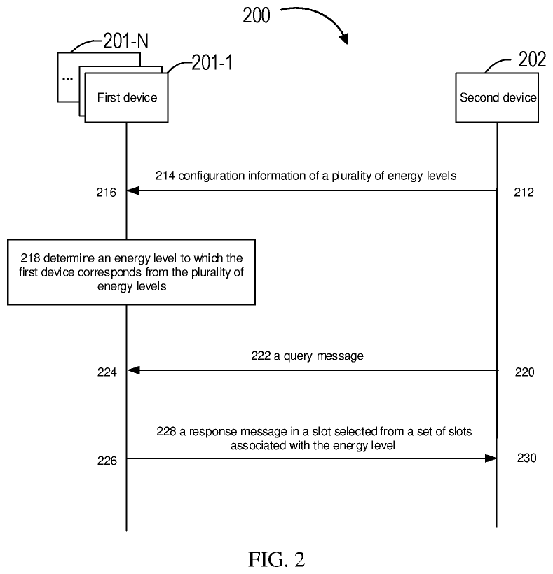

FIG. 2 illustrates an example flowchart showing an example process 200 for configuring energy levels and collision arbitrations in accordance with some embodiments of the present disclosure. For the purpose of discussion, the process 200 will be described with reference to FIG. 1. The process 200 may involve the second device 202 (e.g., the network device 110 or the terminal device 123 in FIG. 1) and the first devices 201-1 . . . 201-N (collectively referred to as the first device 201). The first device 201 may be, e.g., one or more of the terminal devices 121, 122, 124, and 125 in FIG. 1. The second device 202 can communicate with each of the first devices 201-1 . . . 201-N.

As shown in FIG. 2, the second device 202 transmits 212 to the first device 201 configuration information of a plurality of energy levels 214. After receiving 216 the configuration information of a plurality of energy levels, the first device 201 determines 218, based on the configuration information, an energy level to which the first device 201 corresponds from the plurality of energy levels. The second device 202 transmits 220 a query message 222. After receiving 224 the query message 222, the first device 201 provides 226 (e.g., backscatters, returns, transmits, etc.) a response message 228 to the second device 202 in a slot selected by the first device 201 from a set of slots associated with the energy level. The second device 202 receives the response message 228.

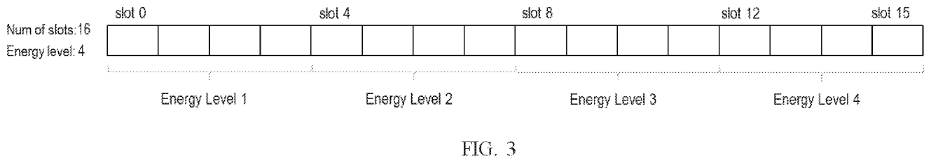

FIG. 3 illustrates an example diagram of a relationship between the slots and the energy levels in accordance with some embodiments of the present disclosure. In the slotted random collision arbitration algorithm, if parameter Q=4, number of slots is 24=16, the number of energy levels can be assumed to be 4. Accordingly, as shown in FIG. 3, the slots are divided into four groups, for example, slot 0-slot 3 are assigned to the terminal devices with energy level 1, slot 4-slot 7 are assigned to the terminal devices with energy level 2, and so on. In some example embodiments, the slots may also be divided into groups of non-uniform or unequal sizes.

The gNB indicates energy level division and the thresholds to the terminal devices according to the received signal power (e.g., RSRP) level. For example, energy level 1 means that the terminal devices in this level can respond after receiving the query message once, while a terminal device at energy level K at least receives signal K times. The query has query number in it for the tags to know their Kth turn. The terminal device determines which level it belongs to based on the received signal power it measured.

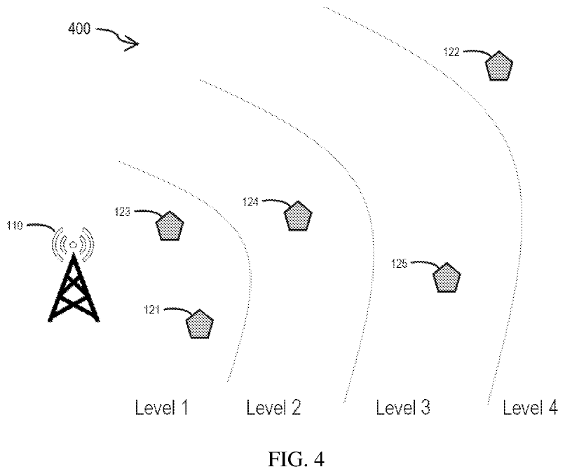

FIG. 4 illustrates an example diagram 400 of a deployment of tags and the energy levels in accordance with some embodiments of the present disclosure. For the purpose of discussion, the diagram 400 will be described with reference to FIG. 1. The diagram 400 may involve the network device 110 and the terminal devices 121-125 in FIG. 1.

In general, the terminal device near the network device may be classified as belonging to energy level 1, and the terminal device far away from the network device may be classified as belonging to energy level 4 in this example. For example, as shown in FIG. 4, the terminal devices 121 and 123 may determine that they belong to the energy level 1, the terminal device 124 may determine that it belongs to the energy level 2, the terminal device 125 may determine that it belongs to the energy level 3, and the terminal device 122 may determine that it belongs to the energy level 4. During the collision arbitration procedure, the terminal devices in each energy level only select a random slot within the range to which they are assigned.

In FIG. 4, the terminal device near the network device may respond preferentially to the query signal sent by network device, for example in slot 0-slot 3. The terminal device far away from the network device may perform RF energy harvesting from several query signals before responding in a slot it selects. The harvested energy may be stored in a capacitor, a battery, or some other form of energy storage and used to enhance the backscattering signal, i.e., backscattering the query signal in its selected slot. In other example embodiments, the terminal devices may harvest RF energy from the signal transmitted by the network device and transmit data at a later time in in the respective selected slots, i.e., (energy)-harvest-then-transmit (HTT).

In some embodiments, the energy level division could be based on beam reports, e.g., an SSB index. A2D beam grid and an SSB index may approximately indicate where a terminal device is located.

It is to be understood that FIG. 4 is given for the purpose of illustration without suggesting any limitations to the present disclosure. The collision arbitration mechanism based on energy levels of the present disclosure is not limited to scenarios between the network device and terminal devices. More generally, tags (e.g., terminal devices such as the terminal devices 121, 122, 124 and 124) may determine energy levels to which they correspond based on a measurement of a signal from a reader (e.g., the network device 110 or a terminal device such as the terminal device 123), and tags may respond to the query signal sent by the reader in their selected slots.

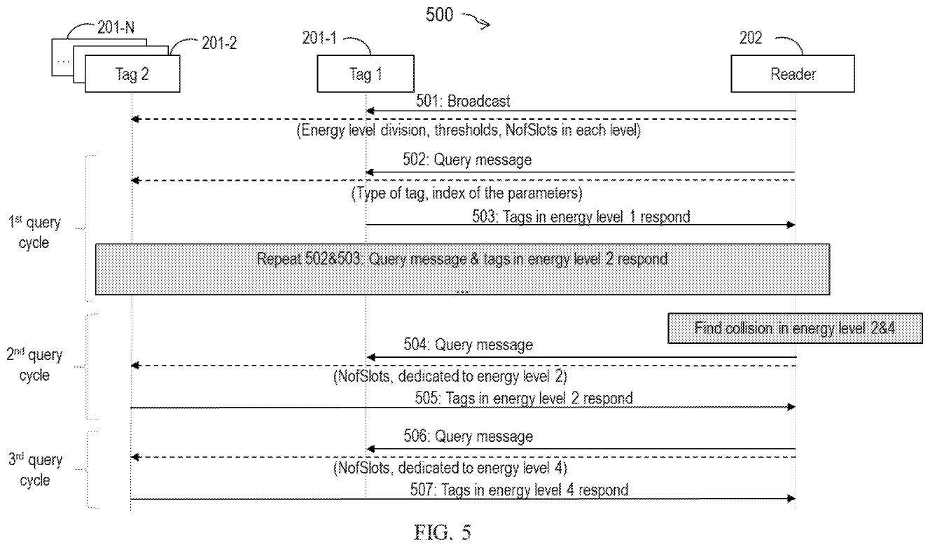

FIG. 5 illustrates an example flowchart showing an example detailed process 500 of collision arbitration based on energy levels in accordance with some embodiments of the present disclosure. For the purpose of discussion, the process 500 may involve the reader 202 (e.g., the network device 110 or the terminal device 123) and the tags 201-1 . . . 201-N (collectively referred to as the tags 201). Note that the tags 201 may comprise any suitable number of tags. The reader 202 can communicate with each of the tags 201-1 . . . 201-N.

As shown in FIG. 5, at step 501 (e.g., an initial step), the reader broadcasts the energy level division criterion (this could be RSRP measurements, an SSB index, etc., or a combination thereof), the thresholds for the criterion, and the number of slots in SIB. The procedure to configure these energy levels will be described later.

At step 502, the reader sends a query message which may include parameters such as a type of the tag (e.g., a query of all temperature sensors in the cell), an index of the list in step 501, (e.g., 4 energy levels and 16 slots).

At step 503, when receiving a query message, the tags with energy level 1 respond to the query message. For example, each of the participating tags with energy level 1 select a random slot within the range of (0, 3), tags in energy level 2 select a random slot within the range of (4, 7), and so on. The tags will respond with their ID (e.g., a unique identity (UID)) using backscattering or transmitting a response message directly in their selected slots. Steps 502 and 503 may be repeated. The participating tags with energy levels 1-4 respond in their selected slots respectively. The reader may determine conflicted tags existed with energy levels 2 and 4 based on receiving response messages originating from the conflicted tags in a same slot. Then, the conflicting tags wait for a subsequent query cycle.

In a second query cycle, at step 504, the reader sends a query message which includes a number of slots (e.g., a NofSlots field of 8), and the query message corresponds to energy level 2. At step 505, the conflicted tags of energy level 2 in the first query cycle may respond in these slots.

In the third query cycle, at step 506, the reader sends a query message which includes a number of slots (e.g., a NofSlots field of 8), and the query message corresponds to energy level 4. At step 507, the conflicted tags with energy level 4 in the first query cycle may respond in these slots.

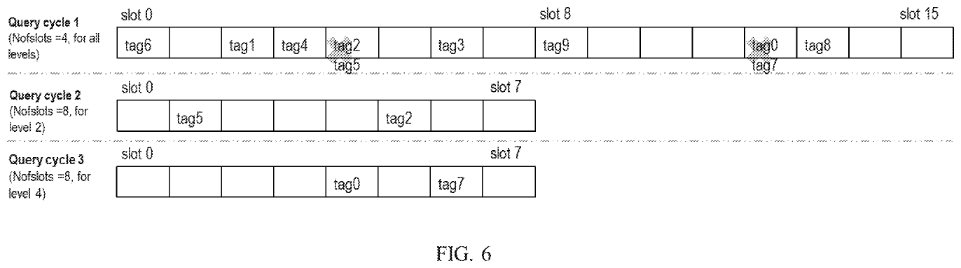

FIG. 6 illustrates an example diagram of the response of each tag for the query message in accordance with some embodiments of the present disclosure. As shown in FIG. 6, tag1, tag4, and tag6 are in the group with energy level 1, and they respond to the query messages in slot 0-slot 3. When receiving a query message, tag1, tag4, and tag6 select a random number within the range of (0, 3) and put this number into their slot counter. Tags that selected zero value respond immediately and reply with their respective UID; tags that selected non-zero numbers may wait for the query in the corresponding slot. Similarly, other tags in different energy levels may respond to the query in their selected slots later.

The second device may detect that there are collisions in slot 4 and slot 12 corresponding to energy level 2 and energy level 4, respectively. In the second query cycle, the second device may initialize the query message dedicated to the tags in energy level 2. In the third query cycle, the second device may initiate the query message dedicated to the tags in energy level 4 until the collision is alleviated.

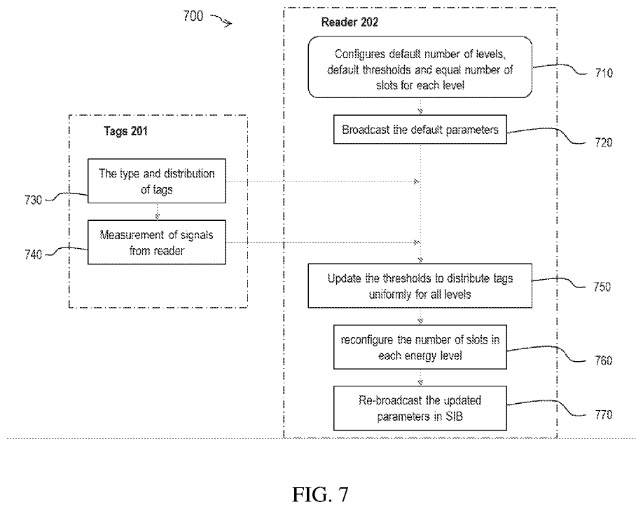

FIG. 7 illustrates an example flowchart showing an example process 700 of dynamic parameters determination for energy levels in accordance with some embodiments of the present disclosure. Reference is made to FIG. 7 to discuss how the second device determines the number of energy levels, the thresholds for the energy levels, and the number of slots.

In some embodiments, the reader can start with some default number of levels (e.g., 3 or 4). It can also configure some default thresholds and equal number of slots for each level, as shown in 710. For example, the default values may vary according to the type and distribution of tags in cell. The parameter ‘number of levels’ is a dynamic number, dynamic to configure how many levels are needed based on location and density of tags.

At 720, the reader may broadcast the default parameters. Then, the tags may obtain and transmit at 730 and 740 some reports (for example, an SSB index report for beam management or timing advance) or measurements of signals from the reader. The reader can determine how many tags are in each level based on the reports and measurements.

At 750, the reader can update the thresholds to distribute the tags according to a desired distribution in the levels, e.g., to distribute the tags uniformly for all levels. Additionally or alternatively, at 760, the reader can reconfigure the number of slots in each energy level such that energy levels with more tags have more slots. So, the number of slots in different energy levels can be unequal. Then, at 770, the updated parameters can be re-broadcast in SIB.

According to the above embodiments of the present disclosure, there is providing solutions on the energy levels definition and the collision arbitration based on the energy levels for energy harvesting passive IoT in 5GS. With the proposed solutions, the reader (e.g., the gNB or a terminal device) will repeatedly send query message with normal power, so the near passive IoT device can respond first, while the far passive IoT device can respond later, for example, after receiving query signal several times. In this way, the power consumption is minimized. Furthermore, the slot number can be configurable between query cycles. After each subsequent query cycle, collision arbitration may be performed more accurately and/or more efficiently, and thereby also reduce arbitration time.

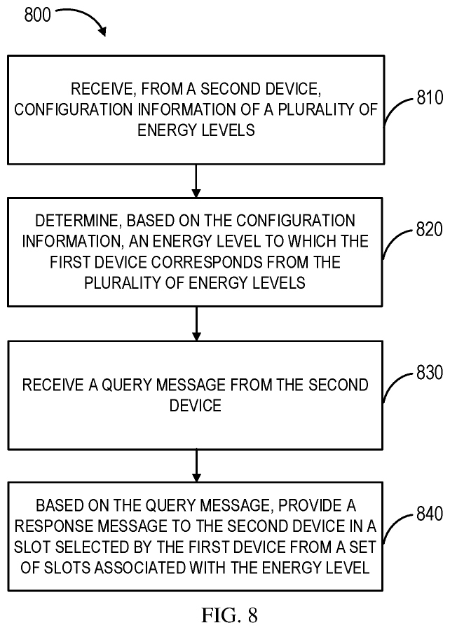

FIG. 8 illustrates a flowchart of an example method 800 implemented at a first device in accordance with some embodiments of the present disclosure. For the purpose of discussion, the method 800 will be described from the perspective of the first device 201 as shown in, e.g., FIG. 2.

At block 810, the first device 201 receives, from a second device 202, configuration information of a plurality of energy levels. At block 820, based on the configuration information, the first device 201 determines an energy level to which the first device 201 corresponds from the plurality of energy levels. At block 830, the first device 201 receives a query message from the second device 202. At block 840, based on the query message, the first device 201 provides a response message to the second device 202 in a slot selected by the first device from a set of slots associated with the energy level.

In some embodiments, the plurality of energy levels may be associated with different values of a measurement at the first device based on an energy level selection criterion. In some embodiments, the configuration information may comprise the energy level selection criterion. Additionally or alternatively, the configuration information may comprise one or more thresholds for the determining of the energy level to which the first device corresponds from the plurality of energy levels based on the energy level selection criterion. Additionally or alternatively, the configuration information may comprise a number of slots associated with one or more of the plurality of energy levels.

In some embodiments, the energy level selection criterion may comprise a received signal power measurement result. Additionally or alternatively, the energy level selection criterion may comprise an SSB index measurement result. Additionally or alternatively, the energy level selection criterion may comprise a distance measurement to a reference location based on a location of the first device.

In some embodiments, the query message may comprise a type of the first device. Additionally or alternatively, the query message may comprise a range of an identity including a UID of the first device. Additionally or alternatively, the query message may comprise a group identity associated with the first device. In some embodiments, the response message may comprise a UID of the first device.

In some embodiments, the first device 201 may harvest energy from a plurality of query messages transmitted in a plurality of slots prior to the selected slot. The query message may be one of the plurality of query messages. Moreover, the first device 201 may store the harvested energy in an energy storage element and provide the response message to the second device in the selected slot based on the stored energy.

In some embodiments, the first device 201 may backscatter a signal with low illuminating power and carrying the query message or following the query message by using the stored energy to amplify power of the backscattered signal. Additionally or alternatively, the first device 201 may transmit the response message directly using the stored energy.

In some embodiments, after providing the response message to the second device, the first device 201 may receive a further query message comprising an additional set of slots for the energy level. Moreover, the first device 201 may provide a further response message to the second device in a slot selected by the first device from the additional set of slots.

In some embodiments, a number of slots in the additional set of slots may be different from a number of slots in the set of slots. Additionally or alternatively, the number of slots in the additional set of slots may be same as the number of slots in the set of slots. In some embodiments, the configuration information may indicate a dynamically updated configuration. Additionally or alternatively, the configuration information may be received in a SIB.

In some embodiments, a plurality of sets of slots may be associated with the plurality of respective energy levels. The plurality of sets of slots may have a same number of slots or different numbers of slots. In some embodiments, the first device may be a terminal device comprising an energy harvesting device, and the second device may be a network device or another terminal device.

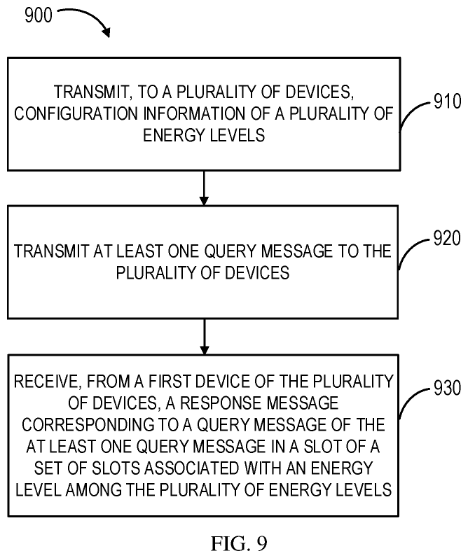

FIG. 9 illustrates a flowchart of an example method 900 implemented at a second device in accordance with some embodiments of the present disclosure. For the purpose of discussion, the method 900 will be described from the perspective of the second device 202 as shown in, e.g., FIG. 2.

At block 910, the second device 202 transmits, to a plurality of devices, configuration information of a plurality of energy levels. At block 920, the second device 202 transmits at least one query message to the plurality of devices 201. At block 930, the second device 202 receives, from a first device 201 of the plurality of devices, a response message corresponding to a query message of the at least one query message in a slot of a set of slots associated with an energy level among the plurality of energy levels.

In some embodiments, the plurality of energy levels may be associated with different values of a measurement at the plurality of devices based on an energy level selection criterion. In some embodiments, the configuration information may comprise the energy level selection criterion. Additionally or alternatively, the configuration information may comprise one or more thresholds for determining the plurality of energy levels based on the energy level selection criterion. Additionally or alternatively, the configuration information may comprise a number of slots associated with one or more of the plurality of energy levels.

In some embodiments, the energy level selection criterion may comprise a received signal receiving power measurement result. Additionally or alternatively, the energy level selection criterion may comprise an SSB index measurement result. Additionally or alternatively, the energy level selection criterion may comprise a distance measurement to a reference location based on a location of the first device of the plurality of devices.

In some embodiments, the second device 202 may determine the configuration information based on a default configuration comprising default values for parameters in the configuration information depending on at least one of types of the plurality of devices and a distribution of the plurality of devices in a served area. In some embodiments, the second device 202 may determine the configuration information based further on at least one location of one or more of the plurality of devices. Additionally or alternatively, the second device 202 may determine the configuration information based further on at least one report of SSB index measurements from one or more of the plurality of devices. Additionally or alternatively, the second device 202 may determine the configuration information based further on at least one report of received signals power measurements from one or more of the plurality of devices.

In some embodiments, the second device 202 may perform load balancing between the plurality of energy levels based on a plurality of response messages from the plurality of devices. Moreover, the second device 202 may update the configuration information based on the load balancing. In some embodiments, the second device 202 may update the configuration information by updating the threshold of the energy level selection criterion to distribute the plurality of devices according to a desired distribution in the plurality of energy levels. In some embodiments, the second device 202 may update the configuration information by updating the configuration information such that a number of slots in an energy level of the plurality of energy levels correspond to a number of devices associated with the energy level.

In some embodiments, the at least one query message may comprise a type of the plurality of devices. Additionally or alternatively, the at least one query message may comprise a range of an identity including a UID of the plurality of devices. Additionally or alternatively, the at least one query message may comprise a group identity associated with the plurality of devices. In some embodiments, the response message may comprise a UID of the first device.

In some embodiments, the second device 202 may determine conflicted devices based on receiving response messages originating from the conflicted devices in a same slot. Moreover, the second device 202 may determine an energy level to which the conflicted devices correspond. In some embodiments, the second device 202 may transmit a further query message intended for the conflicted devices. The further query message may comprise an additional set of slots for the energy level to which the conflicted devices correspond. In some embodiments, the second device 202 may receive a further response message originating from a conflicted device of the conflicted devices in a slot selected by the conflicted device from the additional set of slots.

In some embodiments, a number of slots in the additional set of slots may be different from a number of slots in the set of slots. Additionally or alternatively, the number of slots in the additional set of slots may be same as the number of slots in the set of slots. In some embodiments, the second device 202 may transmit the configuration information by transmitting the configuration information in an SIB.

In some embodiments, a plurality of sets of slots may be associated with to the plurality of respective energy levels. The plurality of sets of slots may have a same number of slots or different numbers of slots. In some embodiments, the first device may be a terminal device comprising an energy harvesting device, and the second device may be a network device or another terminal device.

In some embodiments, an apparatus capable of performing any of the method 800 (for example, the first device 201) may comprise means for performing the respective steps of the method 800. The means may be implemented in any suitable form. For example, the means may be implemented in a circuitry or software module.

In some embodiments, the apparatus comprises means for: receiving, at a first device and from a second device, configuration information of a plurality of energy levels; determining, based on the configuration information, an energy level to which the first device corresponds among the plurality of energy levels; receiving a query message from the second device; and based on the query message, provide a response message to the second device in a slot selected by the first device from a set of slots associated with the energy level.

In some embodiments, the plurality of energy levels is associated with different values of a measurement at the first device based on an energy level selection criterion. In some embodiments, the configuration information comprises at least one of the following parameters: the energy level selection criterion; one or more thresholds for the determining of the energy level to which the first device corresponds from the plurality of energy levels based on the energy level selection criterion; and a number of slots associated with one or more of the plurality of energy levels.

In some embodiments, the energy level selection criterion comprises at least one of: a received signal power measurement result; a synchronization signal and physical broadcast channel block, SSB, index measurement result; and a distance measurement to a reference location based on a location of the first device. In some embodiments, the query message comprises at least one of: a type of the first device; and a range of an identity including a unique identity, UID, of the first device; or a group identity associated with the first device.

In some embodiments, the response message comprises a UID of the first device. In some embodiments, the means for providing the response message to the second device comprises means for: harvesting energy from a plurality of query messages transmitted in a plurality of slots prior to the selected slot, the query message being one of the plurality of query messages; storing the harvested energy in an energy storage element; and providing, based on the stored energy, to the second device, the response message in the selected slot.

In some embodiments, the means for providing the response message based on the stored energy comprises means for: backscattering a signal with low illuminating power and carrying the query message or following the query message by using the stored energy to amplify power of the backscattered signal; or transmitting the response message directly using the stored energy.

In some embodiments, the apparatus further comprises means for: after providing the response message to the second device, receiving a further query message comprising an additional set of slots for the energy level; and providing a further response message to the second device in a slot selected by the first device from the additional set of slots. In some embodiments, a number of slots in the additional set of slots is different from a number of slots in the set of slots, or the number of slots in the additional set of slots is same as the number of slots in the set of slots.

In some embodiments, the configuration information indicates a dynamically updated configuration, or the configuration information is received in a system information block, SIB. In some embodiments, a plurality of sets of slots are associated with the plurality of respective energy levels, the plurality of sets of slots having a same number of slots or different numbers of slots. In some embodiments, the first device is a terminal device comprising an energy harvesting device, and the second device is a network device or another terminal device.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

In some embodiments, an apparatus capable of performing any of the method 900 (for example, the second device 202) may comprise means for performing the respective steps of the method 900. The means may be implemented in any suitable form. For example, the means may be implemented in a circuitry or software module.

In some embodiments, the apparatus comprises means for: transmitting, at a second device and to a plurality of devices, configuration information of a plurality of energy levels; transmitting at least one query message to the plurality of devices; and receiving, from a first device of the plurality of devices, a response message corresponding to a query message of the at least one query message in a slot of a set of slots associated with an energy level among the plurality of energy levels.

In some embodiments, the plurality of energy levels is associated with different values of a measurement at the plurality of devices based on an energy level selection criterion. In some embodiments, the configuration information comprises at least one of the following parameters: the energy level selection criterion; one or more thresholds for determining the plurality of energy levels based on the energy level selection criterion; and a number of slots associated with one or more of the plurality of energy levels.

In some embodiments, the energy level selection criterion comprises at least one of: a received signal receiving power measurement result; a synchronization signal and physical broadcast channel block, SSB, index measurement result; and a distance measurement to a reference location based on a location of the first device of the plurality of devices.

In some embodiments, the means for the determining configuration information comprises means for: determining configuration information based on a default configuration comprising default values for parameters in the configuration information depending on at least one of types of the plurality of devices and a distribution of the plurality of devices in a served area.

In some embodiments, the means for the determining configuration information further comprises means for: determining configuration information based on at least one location of one or more of the plurality of devices; at least one report of SSB index measurements from one or more of the plurality of devices; and at least one report of received signals power measurements from one or more of the plurality of devices.

In some embodiments, the apparatus further comprises means for: performing load balancing between the plurality of energy levels based on a plurality of response messages from the plurality of devices; and updating the configuration information based on the load balancing. In some embodiments, the means for the updating the configuration information comprises means for: updating the threshold of the energy level selection criterion to distribute the plurality of devices according to a desired distribution in the plurality of energy levels.

In some embodiments, the means for the updating the configuration information comprises means for: updating the configuration information such that a number of slots in an energy level of the plurality of energy levels correspond to a number of devices associated with the energy level. In some embodiments, the at least one query message comprises at least one of: a type of the plurality of devices; and a range of an identity including a unique identity, UID, of the plurality of devices; or a group identity associated with the plurality of devices. In some embodiments, the response message comprises a UID of the first device.

In some embodiments, the apparatus further comprises means for: determining conflicted devices based on receiving response messages originating from the conflicted devices in a same slot; and determining an energy level to which the conflicted devices correspond.

In some embodiments, the apparatus further comprises means for: transmitting a further query message intended for the conflicted devices, wherein the further query message comprises an additional set of slots for the energy level to which the conflicted devices correspond; and receiving a further response message originating from a conflicted device of the conflicted devices in a slot selected by the conflicted device from the additional set of slots.

In some embodiments, a number of slots in the additional set of slots is different from a number of slots in the set of slots; or the number of slots in the additional set of slots is same as the number of slots in the set of slots. In some embodiments, the means for the transmitting the configuration information comprises means for: transmitting the configuration information in a system information block, SIB. In some embodiments, a plurality of sets of slots are associated with to the plurality of respective energy levels, the plurality of sets of slots having a same number of slots or different numbers of slots. In some embodiments, the first device is a terminal device comprising an energy harvesting device, and the second device is a network device or another terminal device.

In some embodiments, the apparatus further comprises means for performing other steps in some embodiments of the method 900. In some embodiments, the means comprises at least one processor; and at least one memory including computer program code, the at least one memory and computer program code configured to, with the at least one processor, cause the performance of the apparatus.

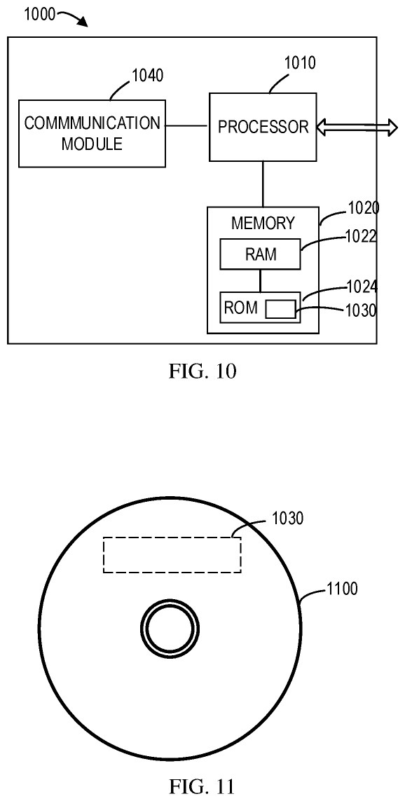

FIG. 10 is a simplified block diagram of a device 1000 that is suitable for implementing embodiments of the present disclosure. The device 1000 may be provided to implement the communication device, for example the first device 201 and the second device 202 the network device 230. As shown, the device 1000 includes one or more processors 1010, one or more memories 1040 coupled to the processor 1010, and one or more communication modules (TX/RX) 1040 coupled to the processor 1010.

The TX/RX 1040 is for bidirectional communications. The TX/RX 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1020. The processor 1010 may perform any suitable actions and processing by loading the program 1030 into the RAM 1020.

The embodiments of the present disclosure may be implemented by means of the program 1030 so that the device 1000 may perform any process of the disclosure as discussed with reference to FIGS. 2 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a transitory or non-transitory computer readable storage medium. The computer program product includes computer-executable instructions, such as those included in program modules, being executed in a device on a target real or virtual processor, to carry out the methods 800-900 as described above with reference to FIGS. 8 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. This program code may be provided to a processor or controller of a general purpose computer, special purpose computer, or other programmable data processing device, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the instructions or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to:
receive, from a second device, configuration information of a plurality of energy levels;
determine, based on the configuration information, an energy level to which the first device corresponds from the plurality of energy levels;
receive a query message from the second device; and
based on the query message, provide a response message to the second device in a slot selected by the first device from a set of slots associated with the energy level.

2. The first device of claim 1, wherein the plurality of energy levels is associated with different values of a measurement at the first device based on an energy level selection criterion.

3. The first device of claim 2, wherein the configuration information comprises at least one of the following parameters:
the energy level selection criterion;
one or more thresholds for the determining of the energy level to which the first device corresponds from the plurality of energy levels based on the energy level selection criterion; and
a number of slots associated with one or more of the plurality of energy levels.

4. The first device of claim 2, wherein the energy level selection criterion comprises at least one of:
a received signal power measurement result;
a synchronization signal and physical broadcast channel block, SSB, index measurement result; and
a distance measurement to a reference location based on a location of the first device.

5. The first device of claim 1, wherein the query message comprises at least one of:
a type of the first device; and
a range of an identity including a unique identity, UID, of the first device; or
a group identity associated with the first device.

6. The first device of claim 1, wherein the response message comprises a UID of the first device.

7. The first device of claim 1, wherein the first device is caused to provide the response message to the second device by:
harvesting energy from a plurality of query messages transmitted in a plurality of slots prior to the selected slot, the query message being one of the plurality of query messages;
storing the harvested energy in an energy storage element; and
providing, based on the stored energy, to the second device, the response message in the selected slot.

8. The first device of claim 7, wherein the first device is caused to provide the response message based on the stored energy by at least one of:
backscattering a signal with low illuminating power and carrying the query message or following the query message by using the stored energy to amplify power of the backscattered signal; or
transmitting the response message directly using the stored energy.

9. The first device of claim 1, wherein the first device is further caused to:
after providing the response message to the second device, receive a further query message comprising an additional set of slots for the energy level; and
provide a further response message to the second device in a slot selected by the first device from the additional set of slots.

10. The first device of claim 9, wherein:
a number of slots in the additional set of slots is different from a number of slots in the set of slots; or
the number of slots in the additional set of slots is same as the number of slots in the set of slots.

11. The first device of claim 1, wherein at least one of:
the configuration information indicates a dynamically updated configuration; or
the configuration information is received in a system information block, SIB.

12. The first device of claim 1, wherein a plurality of sets of slots are associated with the plurality of respective energy levels, the plurality of sets of slots having a same number of slots or different numbers of slots.

13. The first device of claim 1, wherein the first device is a terminal device comprising an energy harvesting device, and the second device is a network device or another terminal device.

14. A second device comprising:
at least one processor; and
at least one memory storing instructions that, when executed by the at least one processor, cause the second device at least to:
transmit, to a plurality of devices, configuration information of a plurality of energy levels;
transmit at least one query message to the plurality of devices; and
receive, from a first device of the plurality of devices, a response message corresponding to a query message of the at least one query message in a slot of a set of slots associated with an energy level among the plurality of energy levels.

15. The second device of claim 14, wherein the plurality of energy levels is associated with different values of a measurement at the plurality of devices based on an energy level selection criterion.

16-17. (canceled)

18. The second device of claim 14, wherein the second device is further caused to determine the configuration information based on:
a default configuration comprising default values for parameters in the configuration information depending on at least one of types of the plurality of devices and a distribution of the plurality of devices in a served area.

19-22. (canceled)

23. The second device of claim 14, wherein the at least one query message comprises at least one of:
a type of the plurality of devices; and
a range of an identity including a unique identity, UID, of the plurality of devices; or
a group identity associated with the plurality of devices.

24. (canceled)

25. The second device of claim 14, wherein the second device is further caused to:
determine conflicted devices based on receiving response messages originating from the conflicted devices in a same slot; and
determine an energy level to which the conflicted devices correspond.

26-27. (canceled)

28. The second device of claim 14, wherein the second device is caused to transmit the configuration information by:
transmitting the configuration information in a system information block, SIB.

29. The second device of claim 14, wherein a plurality of sets of slots are associated with to the plurality of respective energy levels, the plurality of sets of slots having a same number of slots or different numbers of slots.

30. (canceled)

31. A method comprising:
receiving, at a first device and from a second device, configuration information of a plurality of energy levels;
determining, based on the configuration information, an energy level to which the first device corresponds among the plurality of energy levels;
receiving a query message from the second device; and
based on the query message, provide a response message to the second device in a slot selected by the first device from a set of slots associated with the energy level.

32. A method comprising:
transmitting, at a second device and to a plurality of devices, configuration information of a plurality of energy levels;
transmitting at least one query message to the plurality of devices; and
receiving, from a first device of the plurality of devices, a response message corresponding to a query message of the at least one query message in a slot of a set of slots associated with an energy level among the plurality of energy levels.

33-35. (canceled)
